(19) United States
(12) Patent Application Publication
(10) Pub. No.: US 2014/0241330 A1
(43) Pub. Date: Aug. 28, 2014

(54) METHOD AND SYSTEM TO PROVIDE RELEVANT LOCAL SERVICE OVER WI-FI

(71) Applicant: Gurubaran Thanigaivel, Chennai (IN)

(72) Inventor: Gurubaran Thanigaivel, Chennai (IN)

(21) Appl. No.: 13/780,267

(22) Filed: Feb. 28, 2013

(51) Int. Cl. H04W 4/02

(52) U.S. Cl. CPC H04W 4/02
USPC 370/338

(57) ABSTRACT

This invention provides method and system for a person to get accurate information about service providers in vicinity to serve real time needs. A user can get information services needed in day-to-day life, which includes but is not limited to house hold, emergency, entertainment etc. The Service Providers are within few km/miles so that User's needs are served when needed. This invention uses Wi-Fi (or future advanced technologies which enhance the wireless reach) technology for implementing this invention without any mobile operators involvement.

### FIELD OF THE INVENTION

Embodiments of the present invention generally relate to Location based Services and, more particularly, to a method and system for providing relevant Customer Services over Wireless Fidelity (Wi-Fi).

### DESCRIPTION OF THE RELATED ART

Millions of people around the globe are using Location based services to locate products and services that they are interested. Some common examples of such services are Google Maps (formerly called Google local) for mobile users that can help to locate yourself and then the services that you are looking for.

The location based services typically used 3-technologies, mobile internet access, position and rich user interfaces. With advent of smart phones and PDAs, it has provided richer interface and supported internet access. The use of location services is projected to be very optimistic. It is said that LBS will once again fill the coffers of Mobile operators and Application developer. The Location Based market is estimated to be in a typical $10-$12 billion range. Broadly the apps supporting LBS can be categorized into a) Driving Directions; b) Maps; c) Local Traffic update; d) Places of interest/City Guide; e) Local Weather Information. Over the years, as smartphone ownership rises, so does the use of location-based features, especially location-based information services and geo-social check-in apps. A recent survey as on February 2012 revealed 74% of smartphone users get real-time location-based information on their phones.

Location-based services like foursquare, Gowalla, Where, and Facebook Places use the geo-location functionality of a mobile phone or smart phone to provide people with information and entertainment. These services allow your customers to “Check-in” wherever they go—like coffee shops, events, restaurants, hotels, airports, or even private residences—in exchange for both tangible and intangible rewards. While Location-based services (LBS) aren't for everyone, they can be good for business! Every time one of the customers checks-in at a business establishment, they're telling their friends about the business establishment and offer free word-of-mouth advertising and promotions.

Our search resulted in several platforms being used to locate Services in the every region. For example, ALOQA, founded in Germany in 2007, markets the ALOQA platform for Location-Based Services, which enables the simple interchange of location information between LBS participants such as the target person, the user, the LBS provider and the content provider. It supports proactivity and push services, recognizing spatial events automatically and making them available to other service providers. Events of this kind can pertain to individual persons, such as their leaving or entering zones, or several users, such as recognizing the distance between two people. It supports an entire range of position-finding processes such as Cell ID, GPS, WLAN and GSM fingerprinting. It also makes a seamless transition between these technologies possible via hybrid positioning strategies.

Google has a product called Google Maps for mobile that runs practically on any mobile device. The application introduces a GPS like location service that does not require a GPS receiver. The “my location” feature works by utilizing the GPS location of the mobile device. The information is supplemented with nearest location of Wireless network and cell sites. Thus, “My Location” is determined by:
GPS-based services
WLAN-, WiFi-based services
Cell transmitter-based services

Thus “My Location” feature can be integrated with Google Maps for Users to get directions from current locations to the nearby facilities and Service Providers.

Our search at US Patent Database reveals several pending and issued patents relating to the implementation of data exchange over one or more of Wi-Fi networks. US Publication Patent No. 2011/0281557 A1 by CHOI et al reveals method and system for providing WiFi service in which multiple counterpart devices are selected based on manufacture information and support information on supported functions with its capability defined as a service in Information field. US Publication Patent No. US 2009/0191892 A1 by Kelly provides Wi-Fi data on a electronic device configured with Wi-Fi and position-determining functionality. This Wi-Fi data is then used to facilitate the device accessing a Wi-Fi network availability within a geographical region associated with the device.

However, what is not available in the current art are the features whereby Service-Provider can register all their current information that can be accessed by Users of applications within or across WiFi network(s) regions without the intervention of mobile operators. Therefore, there is a need in the art for a method and system for providing relevant Location Services over the WiFi network(s).

### SUMMARY OF THE INVENTION

Aspect of the present invention is to provide Users of a mobile application with accurate information about Service-Providers in vicinity to serve real time needs. A User can get services needed in day-to-day life, which includes but is not limited to house hold, emergency, entertainment etc. In context of this invention, a Service-Provider is referred to as any entity or person providing local services over the Wi-Fi, for example any Vendor or Establishment.

Another aspect of the present invention is to allow Service-Providers to register the information with respect to their services, available to be accessed in its vicinity, by the Users seeking such information.

One more aspect of the present invention is to allow Service-Providers to organize the information in relevant categories and sub-categories, so as to enable Users to conveniently access such information.

Further aspect of the present invention is to provide Users who are traveling or are re-located with information on basic service that is consistent, nearby and highly accurate.

Another aspect of the present invention is the use of Wi-Fi (or future advanced technologies which enhance the wireless reach) technology for implementing the invention without any mobile operators involvement.

Another aspect of the present invention is to enable the Wi-Fi devices to set connection with the optimal counterpart Wi-Fi devices as to detect the Service Providers present in vicinity of multiple neighboring Wi-Fi devices.

Another aspect of the present invention is to enable the participating Wi-Fi devices to support forwarding of application data (in the form of customer requests/search results) to the originator of the request by using the intermediate WiFi nodes.

Another aspect of the present invention is to enable Customers to avail information about the Service-Providers present within the same service area.

Another aspect of the present invention is to enable Customers to avail information about the Service-Providers present within multiple service areas.

Other aspects, advantages, and salient features of the invention will become apparent to those skilled in the art from the following detailed description, which, taken in conjunction with the annexed drawings, disclose exemplary embodiments of the invention.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 depicts a block diagram of a system that includes the module of Mobile Application—Framework, according to one or more embodiments of the present invention;

FIG. 2 depicts a block diagram of a system that includes the module of Mobile Application—Framework Example, according to one or more embodiments of the present invention;

FIG. 3 depicts a block diagram of a system that includes the module of Services Options, according to one or more embodiments of the present invention;

FIG. 4 depicts a flowchart of a system that includes the module of Registration of Service by the Service-Provider, according to one or more embodiments of the present invention;

FIG. 5 depicts a flowchart of a system that includes the module of Service-Provider: Enable/Disable Service according to one or more embodiments of the present invention.

FIG. 6 depicts a flowchart of a system that includes the module of Service Provider: De-Register Service according to one or more embodiments of the present invention.

FIG. 7 depicts a flowchart of a system that includes the module of Mobile Application—Customer: Make Service Request according to one or more embodiments of the present invention.

FIG. 8 is a flowchart of a system depicting Cancel Service Request by the Customer according to one or more embodiments of the present invention.

FIG. 9 is a block diagram of a system depicting Services in One Service Area according to one or more embodiments of the present invention.

FIG. 10 is a block diagram of a system depicting Services in Multiple Service Areas according to one or more embodiments of the present invention.

FIG. 11 is a block diagram of a system depicting Data Model and Packet Types Request according to one or more embodiments of the present invention.

### DETAILED DESCRIPTION

In the present description, some words are being used interchangeably to mean the same thing/entity: ‘Customers’ & ‘Users’; ‘He’ and “She”.

It is appreciated that present invention can be implemented in a variety of systems, devices, architectures and configurations. For example, it can be used as an application with several known platforms, such as for, mobile platforms (iPhone, iPad, Android, Windows), distributed computing environment, a cloud computing environment, a client server environment, social networking websites, etc. Embodiments described herein may be discussed in the general context of computer-executable instructions residing on some form of computer-readable storage medium, such as program modules, executed by one or more computers, computing devices, or other devices.

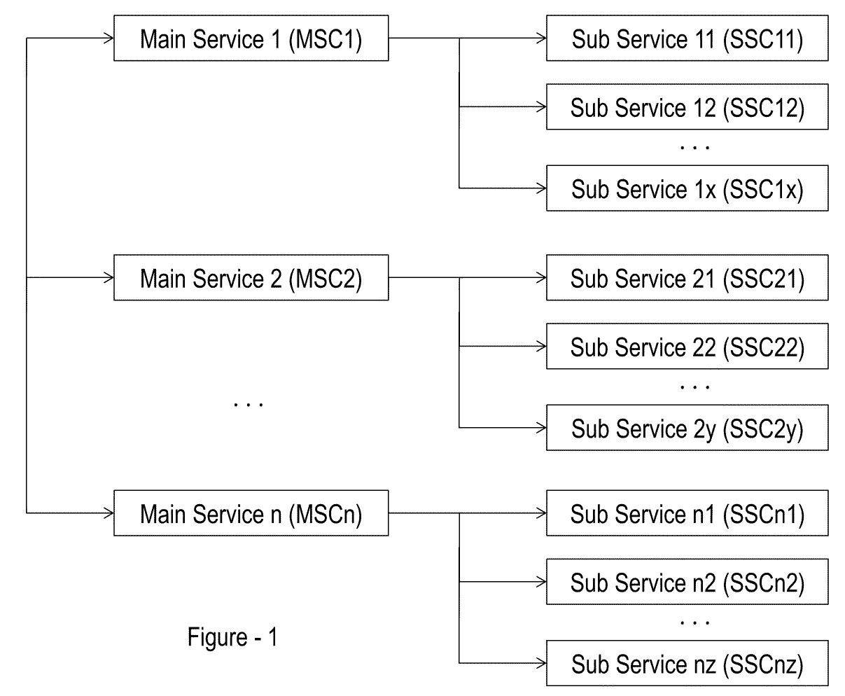

FIG. 1 depicts a block diagram of a system that includes the module of Mobile Application—Framework, according to one or more embodiments of the present invention. Various services are presented in the logical, hierarchal form and are clubbed together. For example, Sub-Service Category (SSC) 11 and SSC 12 are clubbed under the Main Service Category (MSC) 1. When the mobile application is launched the user first sees all the main services. Upon the selection of Main Service Category, the User can select the desired Sub-Service. Once the sub service is selected, the User is provided with information on registered and active Service Provider.

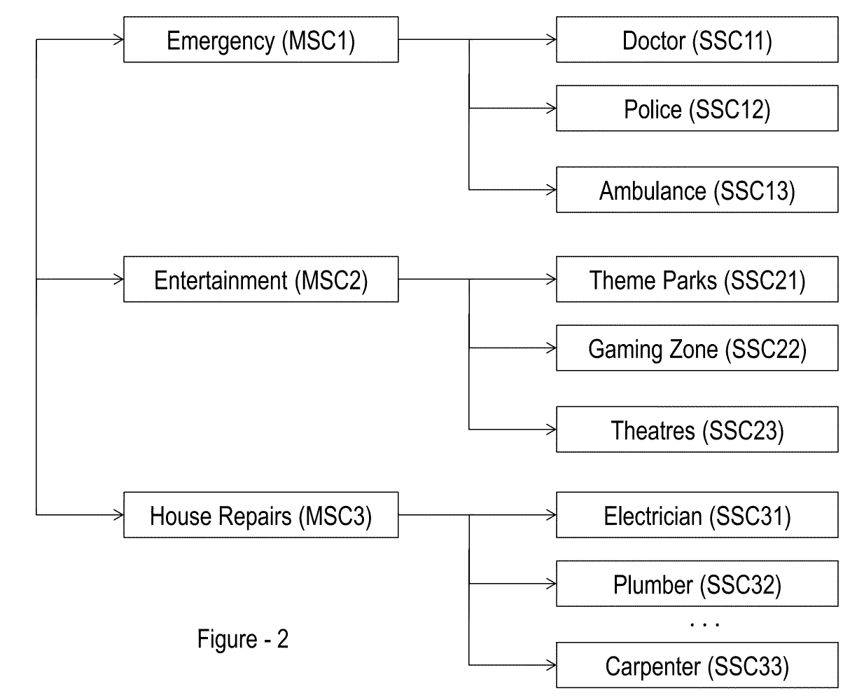

FIG. 2 depicts a block diagram of a system that includes the module of Mobile Application—Framework Example, according to one or more embodiments of the present invention. Under Main-Service of “Emergency”, Sub-Service Category Doctor, Police and Ambulance are clubbed together. Similarly, for Main Service of Entertainment, Sub-Service categories of Theme Park, Gaming Zone and Theatres may be clubbed together. The Application can be modified to include as many Main-Services or Sub-Services as are registered with it, for example:
Emergency Service
Shopping Service
Entertainment Service
Hotel & Restaurant Service
Automobile Service
Financial Service
Education Service
Home Service
Health Service
Travel Service
Rental Service
Real Estate Service
Electrical & Electronic Service
Government Service
Day2Day Service

All the services defined at the sub-category level is assigned a service tag, which can identify the Main-Service and Sub-Service. A service provider has to register his service under the appropriate category and be logged into the application. The details of the service provider will reside in the device (mobile phone) memory.

In one embodiment of implementation of the present invention, the app-owner can seek to have several revenue models for its application. It can charge fees to register Service Providers or may make provisions to charge fees based upon User's selecting to see the information of a Service-Provider. In addition, a revenue model of flat fees of installing App and/or charges for upgrade may also be considered, according to one or more embodiments of the present invention.

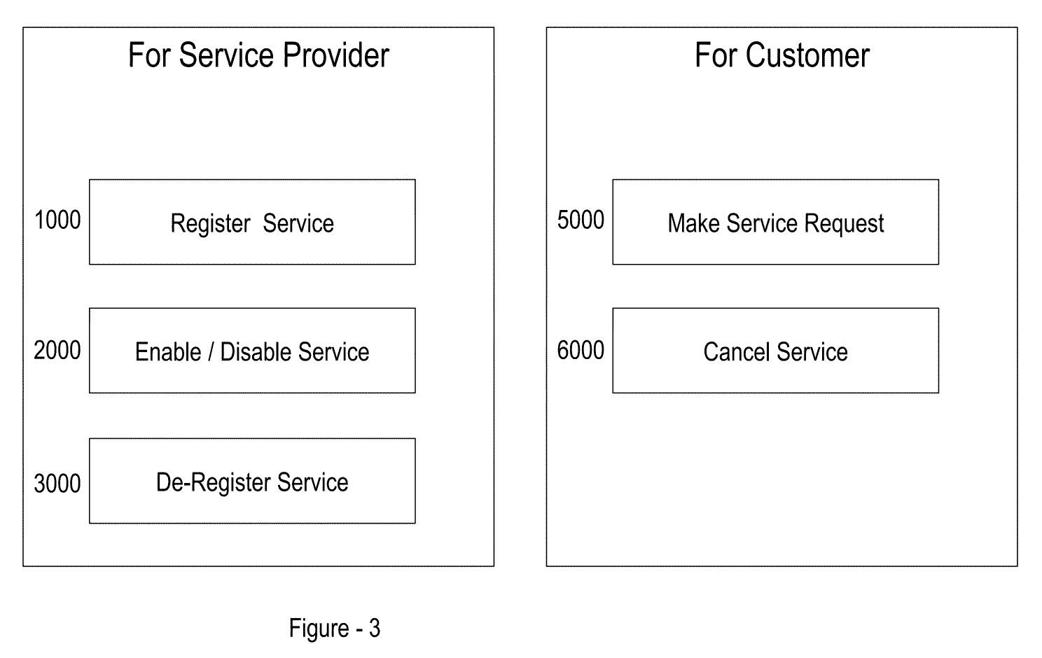

FIG. 3 depicts a block diagram of a system that includes the module of Services Options, according to one or more embodiments of the present invention. A Service Provider can choose any of the following options:
Register Service
Enable/Disable Service
De-Register Service

A Customer may choose any of the following Service options:
Make Service Request
Cancel Service

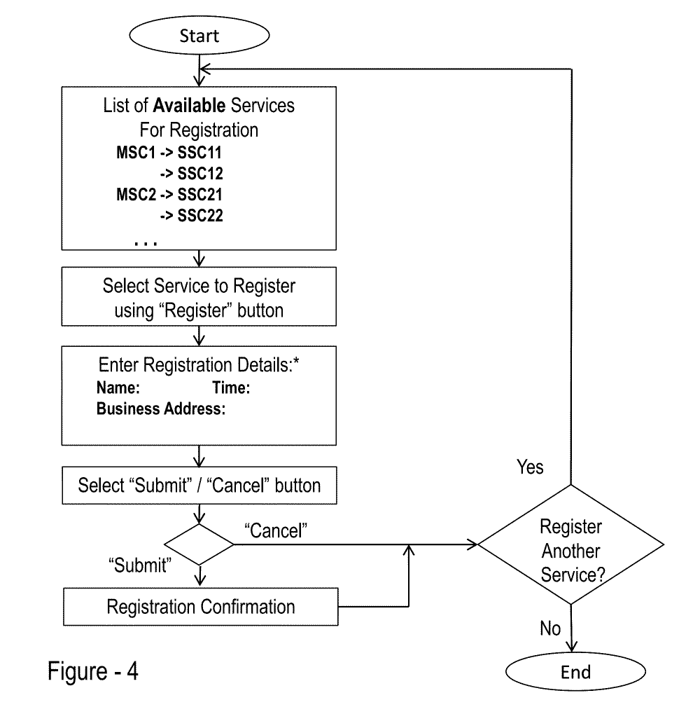

FIG. 4 depicts a flowchart of a system that includes the module of Registration of Service by the Service Provider, according to one or more embodiments of the present invention.

A Service Provider may choose to provide either a single service or multiple services. In the case of providing a single service, the registration can be done once. For multiple services, a service provider has to register as many times as the number of service he wishes to provide under various MSC and SSC categories.

The Service-Provider gets into application as a Service-Provider, then chooses the MSC or SSC and thereafter selects the Register button. The Service-Provider enters all the particulars that includes the following:
Service provider Name (SN)—Optional. If not provided, default Wi-Fi Name will be used.
Service Time (ST)—Optional. If not provided, 24 hours service will be considered. Time is in 24 hour format.
   i) STS—Service Time Start—09:30
   ii) STE—Service Time End—19:00
   iii) Time structure can be used.
Business address.

Once the Service Provider selects Submit button the Registration is completed and message to enable the service is flashed. By default the Service will be disabled. When the service is disabled, the service provider will not be listed in the customer search results.

In a preferred embodiment of the present invention, it is recommended that the Service Provider does the registration from a mobile phone for any service which he/she wants to register. Hence, system will take mobile number automatically and not ask the Service Provider to give mobile number as an input during registration.

After Registration is complete, the Service Provider can select to Register another Service, if needed.

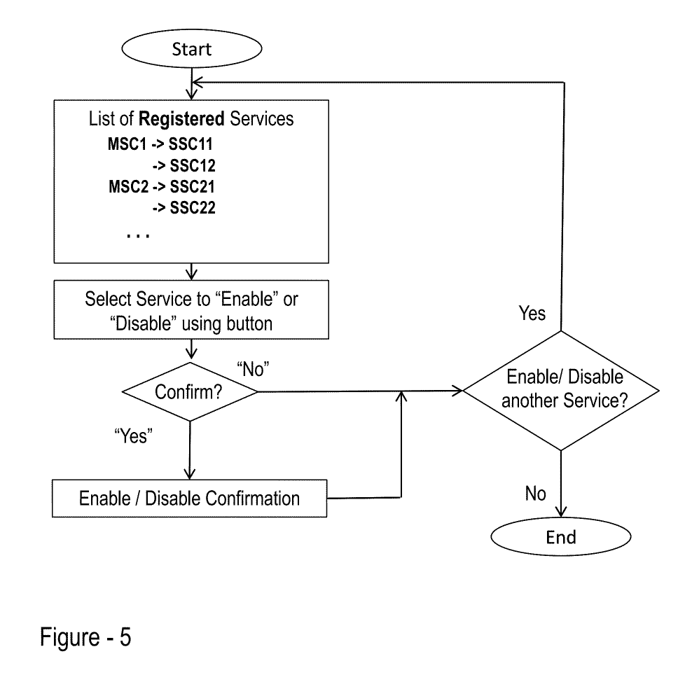

FIG. 5 depicts a flowchart of a system that includes the module of Service Provider: Enable/Disable Service according to one or more embodiments of the present invention. A Service Provider may choose to enable/disable one or more services.

When the Service-Provider selects the Enable/Disable Service Option, he is presented with MSC and SSC menu for only those services the service provider has registered for. The MSC/SSC may not be the complete list as displayed in the registration module. The Service Provider navigates through the registered services and selects the service to enable/disable using the “Enable/Disable” button. Once the Service Provider confirms the selected service is enabled/disabled, as desired. The Service-Provider can also choose to enable/disable one or more services.

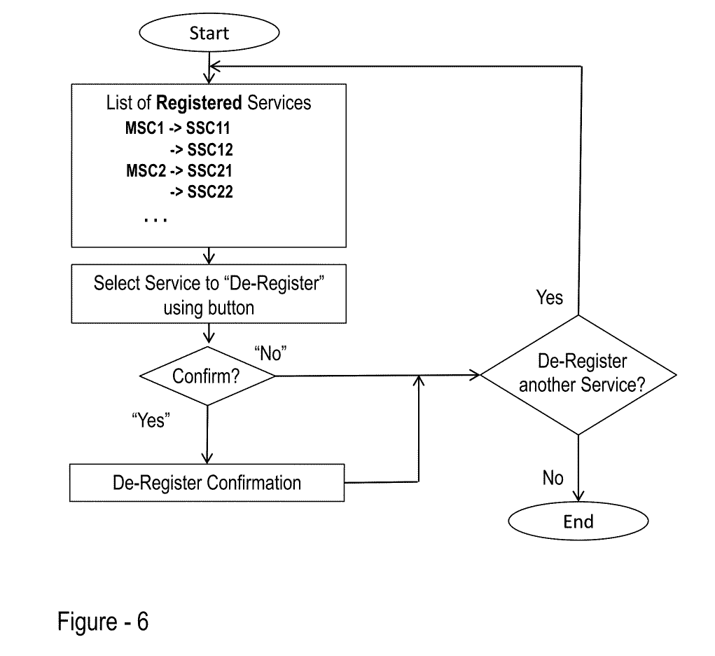

FIG. 6 depicts a flowchart of a system that includes the module of Service Provider: De-Register Service according to one or more embodiments of the present invention. A service provider may choose to De-Register one or more services.

When the Service-Provider selects to De-Register Service Options, he is presented with MSC and SSC menu for only those services the service provider has registered for. The MSC/SSC may not be the complete list as displayed in the registration module. The Service Provider navigates through the registered services and selects the service for De-Register using the “De-Register” button. Once the Service Provider confirms the De-registration, the selected service is De-Registered. The Service-Provider can also choose to De-Register one or more services.

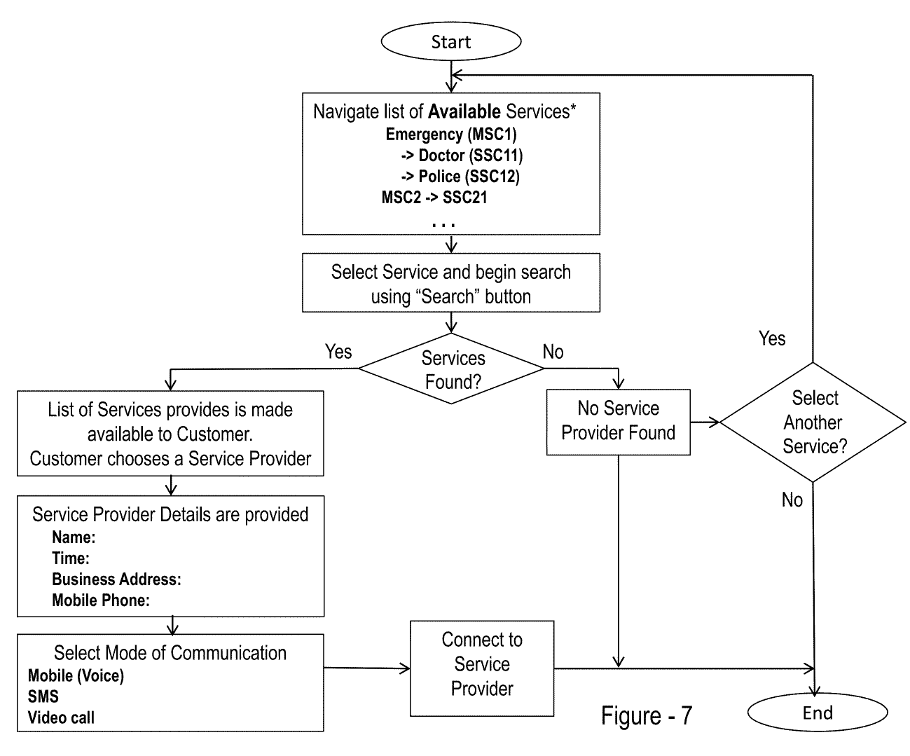

FIG. 7 depicts a flowchart of a system that includes the module of Make Service Request by the Customer, according to one or more embodiments of the present invention.

Customer requesting for a service, need not perform any registration. They need to start the application and start selecting in the MSC and SSC fields and issue a search request.

When the customer selects the Make Service Request Option, he is presented with list of available services. He navigates through MSC & SSC to select the desired service and submits using the search button. The User is given search time option because the user will make the service request and can move to different location in search of a Service Provider. The application should be capable enough to provide option to customer to extend the search time to 5 min/10 min or Continuous Search. Under such option this cancel service becomes more applicable. Maybe decide this at the time of implementation. By default we will have no timeout to support customer search for this very reason. A list of service Provider who can provide the desired service is made available to the Customer, so that the Customer can choose the Service Provider desired. The Service Provider registration details includes, name, Business time (Start, End or 24 hrs), Business address and mobile phone. The Customer can choose the mode of communication that includes mobile, SMS and/or video. The key is to get connected to the Service-Provider. In case there is no Service-Provider found, who can provide the desired service the User is informed about the same. Thereafter, the User can decide to select another service/category that he/she feels more appropriate.

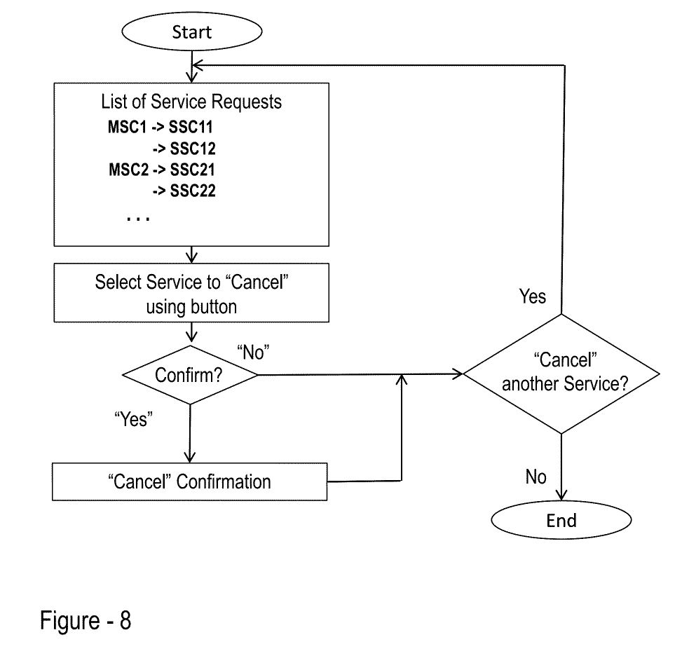

FIG. 8 is a flowchart of a system depicting Cancel Service Request by the Customer according to one or more embodiments of the present invention. The customer may choose to cancel one or more services.

When the Customer selects the Cancel Service Request Option, he is presented with MSC and SSC menu for only those services the User has requested search for. The MSC/SSC may not be the complete list as displayed in the registration module. The Customer navigates through the list of previous service requests made in the form of MSC/SSC and selects the service for Cancel using the “Cancel” button. As explained above for FIG. 7, the application allows Customer to extend search time. Once the Customer confirms the selected service is cancelled, as desired. The Customer can also choose to Cancel one or more services.

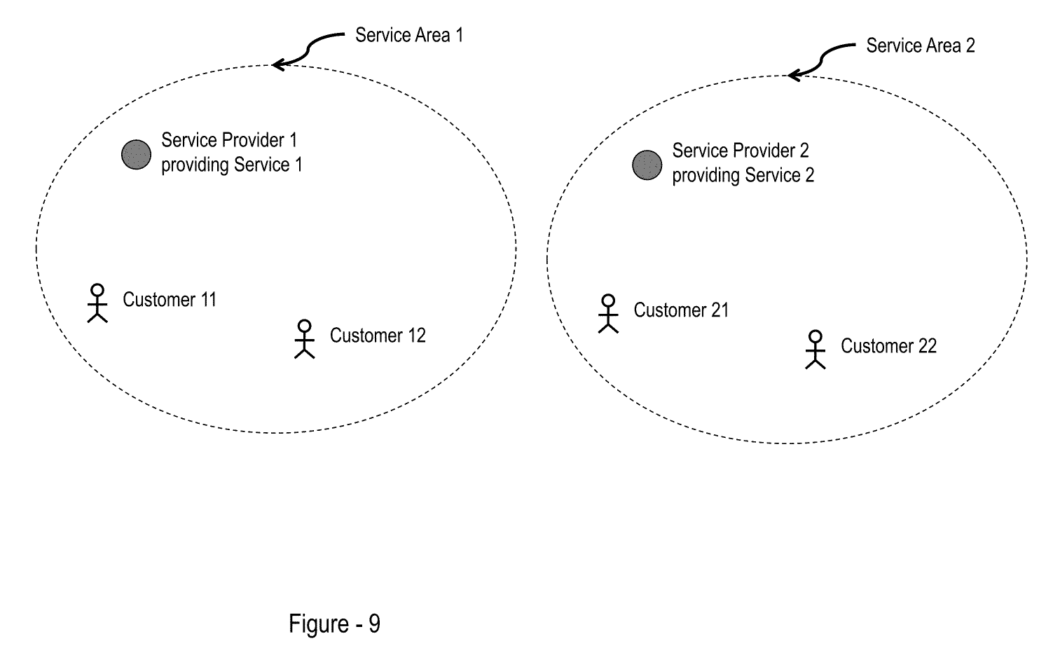

FIG. 9 is a block diagram of a system depicting Services in One Service Area according to one or more embodiments of the present invention. It depicts a simple real time environment for highlighting the core of the invention. The Service Area 1 comprises of Service-1 which is provided by Service Provider 1. Similarly Service Area 2 comprises of Service-2 which is provided by Service Provider 2. When Customer-11 or Customer-12 makes request for Service-1, the Service Provider-1 provides them the information as has been described earlier. The Customer can select the desired service and is connected to the Service Provider-1 who happens to be in the vicinity.

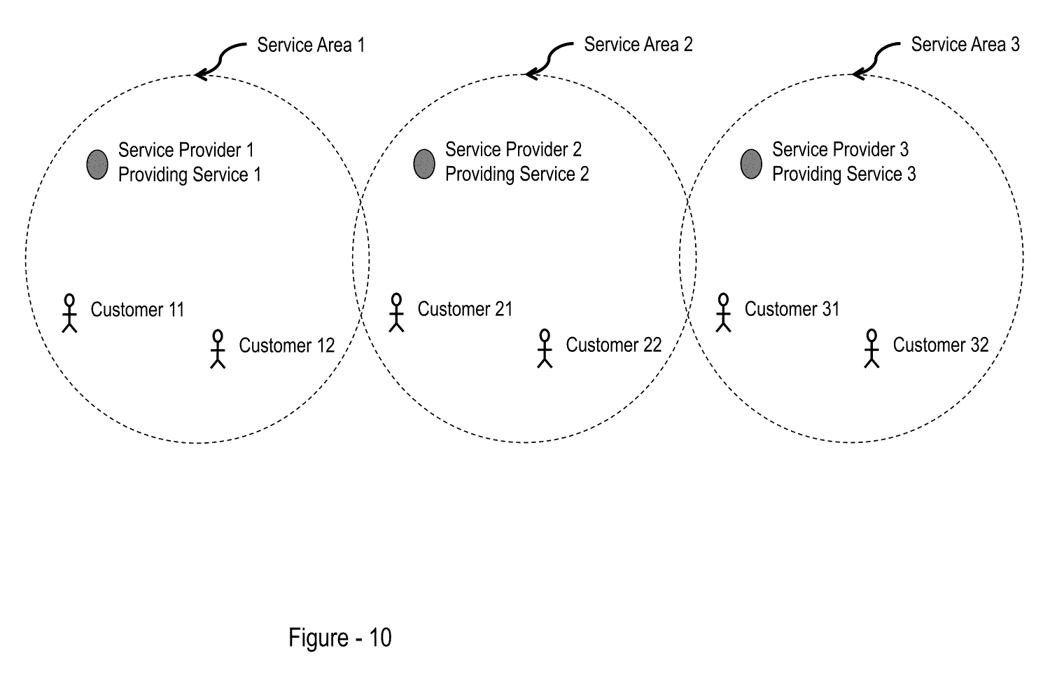

FIG. 10 is a block diagram of a system depicting Services in Multiple Service Areas according to one or more embodiments of the present invention. It depicts the real time environment in which multiple service providers will provide the information about services by passing information to each other. Customer 11 makes request for a service which happens to be in Service Area 3. Service Provide 3 provides info about Service 3 to Service Provider 2 which in turn provides the information to Service Provider 1. Customer 11 selects Service 3 and he/she is served.

The environment of network is needed when Customer 11 makes a request for service that happens to occur in Service Area 3 and that Service Provider 1 is not able to provide the information on Service 3. It in turn, requests the Service Provider 2 and 3 to check if the Services can be provided by them. As Service 3 can be served by Service Provider 3, it passes on this information back to Service Provider 2 which in turn passes this information to Service Provider 1. The Customer can select Service 3 and can be served by this Service Provider, which is not in its immediate vicinity. This enables to increase the coverage/serviceable area beyond the Wi-Fi coverage area.

In another embodiment of the present invention, an additional option of distance between the customer and a service provider can be displayed against the service provider, if Wi-Fi supports calculation of distances between any two P2P Wi-Fi devices using the Round Trip Time (“RTT”).

The Wi-Fi Direct coverage in P2P communication as per the latest specification is 658 feet, roughly 200+ meters. This is a real constraint for obtaining any local service. To improve the coverage area, it is proposed here is to make all the participating Wi-Fi Direct enabled devices (i.e. devices which run this application) to support forwarding of application data (in the form of customer requests/search results) to the originator of the request. This requires embedding the application with knowledge of forwarding the data from and to the customer, with the help of intermediate Wi-Fi nodes permission.

To support this, the participating nodes (who are also potential customers/service provider) or intermediate nodes, need to permit the application to forward data specific to request and search results. This acceptance can be voluntary. Once accepted, the intermediate nodes will act as a Forwarding Agent for the far end nodes.

The coverage can be restricted to number of hop counts, say 50, in which case we can reach a maximum of 50*200 meters which is 10 KM, provided we have so many AP's in between. In a densely populated area (for example in Manhattan, N.Y.), we can expect the intermediate nodes to lie within 50 m, in which case we can expect the range to be 50*50 meters=2.5 KM.

The Idea is to replicate the functioning of Napster File sharing or Torrent File sharing tools like uTorrent application. This is done on the internet, whereas the present invention replicates this model on Wi-Fi direct devices.

The source of request or customer end application can have intelligence to discard the duplicate data based on MSC, SSC and Mobile number. Alternatively, the intermediate nodes can also have the intelligence of filtering duplicate entries and forward only one instance of the service provider. This will not flood the network.
A->B->C->
   ->D->F
      ->G->H
         e.g. If A requests for service m, which H can serve. H's data is forwarded by G and F to D and C. D & C has the duplicate entry of H. Either they can forward the complete data with duplicate entry to B, in which case B will have four duplicate entries. Or they can send one instance of the entry, in which case B will have two entries from one each from C and D. B will now send only one instance of the entry to A.

If somehow B quits the application, A will not receive any responses and A has to retry his request again sometime later, to find if he can get that service.

The present invention envisages, that Customers and Service Providers are not stationed, they are moving at a much faster pace when compared to our coverage which is just 200 meters. Hence, a decision to whether consider the SP_REPLY (as explained below), as valid or not will have to be made in this case.

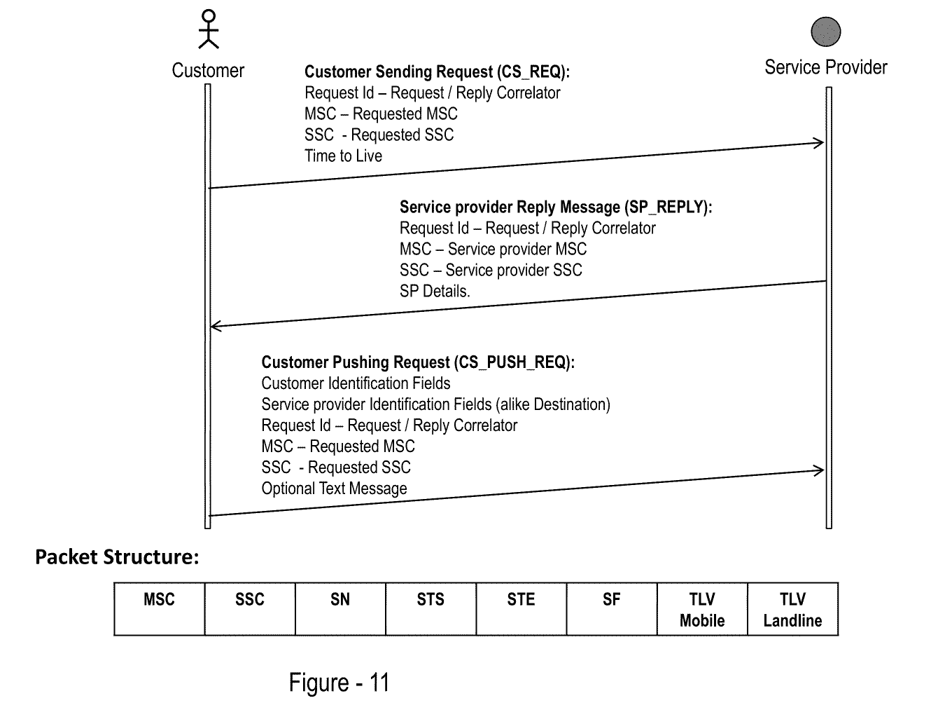

FIG. 11 is a block diagram of a system depicting Data Model and Packet Types Request according to one or more embodiments of the present invention. It depicts the packet exchange between Customer and Service Provider. It also shows the packet structure used.

Customer Sending Request (CS_REQ):
Customer Identification Fields required for reply as per WiFi Direct standards
Request Id—Request/Reply Correlator
MSC—Requested MSC
SSC—Requested SSC
TTL

Service provider Reply Message (SP_REPLY):
Service provider Identification Fields as per WiFi Direct standards
Request Id—Request/Reply Correlator
MSC—Service provider MSC
SSC—Service provider SSC
Other details from SN . . . Mobile Number.
Landline under consideration.

Customer Pushing Request (CS_PUSH_REQ): This is more of a P2P communication
Customer Identification Fields required for reply as per WiFi Direct standards
Service provider Identification Fields (alike Destination) where the request has to be pushed.
Request Id—Request/Reply Correlator
MSC—Requested MSC
SSC—Requested SSC
Optional Text Message

This can be achieved simply buy sending a SMS to the service provider mobile. Nevertheless, we can have it here for simplicity of just push our request to the service provider with just one or two touch, instead of typing the long message followed by mobile number in the trivial SMS communication.

| | | | | | | | |
|---|---|---|---|---|---|---|---|
| MSC | SSC | SN | STS | STE | SF | TLV | TLV |
| | | | | | | Mobile | Landline |

MSC—8 bits, Main Service Category
SSC—8 bits, Sub-Service Category
SN—20 bytes, Service Provide Name
STS—size of time structure to used, Service Time Start
STE—size of time structure to used, Service Time End.
SF—1 bit, Service Flag
TLV Mobile—Unsigned Integer, 12, Value
TLV Landline—Unsigned Integer, 12, Value, under consideration

While the foregoing is directed to embodiments of the present invention, other and further embodiments of the invention may be devised without departing from the basic scope thereof, and the scope thereof is determined by the claims that follow.

1. A system for providing Local Services over Wi-Fi networks (s), the system comprising:
a module to categorizes and sub-categorize services into logical and hierarchal manner to enable Users to select information and location about the desired services in its vicinity;
a module to enable Service Provider to Register information about their services and location into such categories and sub-categories; and
a module to enable users to make request and get desired information about the Registered Service provider in vicinity.
multiple Wi-Fi network(s) that bridge connection between Users and Service-Provider, to enable Users to receive real time updated information about Service-Providers in vicinity,
wherein all the participating WiFi devices support and permit forwarding of application data to the originator of the request without the intervention of a mobile operator.

2. A system as recited in claim 1, wherein creation of Categories or Sub-Categories is flexible to fit-in requirements of each Service Provider.

3. A system as recited in claim 1, wherein information during Registration comprises of Business name, Service-Time and the Business address.

4. A system as recited in claim 1, further comprising of a module to Enable/Disable the Service-Provider to one or more of the subscribed services.

5. A system as recited in claim 1, further comprising of a module to enable the Service-Provider to De-register for one or more subscribed services.

6. A system as recited in claim 1, further comprising of a module to enable Users to choose to Cancel one or more of the subscribed services.

7. A system as recited in claim 1, wherein the Users connect to Service-Providers in one or multiple Services (Network) Areas, by passing on information from one participating device to another participating device, so as to increase the coverage/serviceable area beyond the Wi-Fi coverage.

8. A system as recited in claim 7, wherein the participating devices are built with intelligence to discard the duplicate data based on MSC, SSC and the mobile number, so as to forward only one instance of the data.

9. A system as recited in claim 7, wherein the distance between the customer and Service Provider is calculated using the Round Trip Time (“RTT”) between the participating P2P Wi Fi devices.

10. A system as recited in claim 1, wherein the application data comprises of packet structure that meets WiFi Direct standards.

11. A method for providing Local Services over Wi-Fi networks (s), the method comprising:
creating an application module that categorizes and sub-categorize services into logical and hierarchal manner to enable Users to select information and location about the desired services in its vicinity;
creating an application module to enable Service Provider to Register information about their services and location into such categories and sub-categories; and
creating an application module to enable users to make request and get desired information about the Registered Service provider in vicinity.
providing multiple Wi-Fi network(s) to bridge connection between Users and Service-Provider, to enable Users to receive real time updated information about Service-Providers in vicinity,
wherein all the participating WiFi networks support and permit forwarding of application data to the originator of the request without the intervention of a mobile operator.

12. A method as recited in claim 11, wherein creation of Categories or Sub-Categories is flexible to fit-in requirements of each Service Provider.

13. A method as recited in claim 11, wherein information during Registration comprises of Business name, Service-Time and the Business address.

14. A method as recited in claim 11, further comprising of creating a module to Enable/Disable the Service-Provider to one or more of the subscribed services.

15. A method as recited in claim 11, further comprising of creating a module to enable the Service-Provider to De-register for one or more subscribed services.

16. A method as recited in claim 11, further comprising of creating a module to enable Users to Cancel one or more of the subscribed services.

17. A method as recited in claim 11, wherein the Users connect to Service-Providers in one or multiple Services (Network) Areas, by passing on information from one participating device to another participating device, so as to increase the coverage/serviceable area beyond the Wi-Fi coverage.

18. A method as recited in claim 17, wherein the participating devices discard the duplicate data based on MSC, SSC and the mobile number, so as to forward only one instance of the data.

19. A system as recited in claim 17, wherein the distance between the customer and Service Provider is calculated using the Round Trip Time (“RTT”) between the participating P2P Wi Fi devices.

20. A method as recited in claim 11, wherein the application data is exchanged between the Customer and Service Provider, so as to meet the WiFi Direct standards.
